(19) United States
(12) Patent Application Publication
(10) Pub. No.: US 2006/0050421 A1
(43) Pub. Date: Mar. 9, 2006

(54) Adaptive mirror system

(76) Inventor: Mark A. Ealey, Littleton, MA (US)

Correspondence Address: Iandiorio & Teska, 260 Bear Hill Road, Waltham, MA, 02451-1018, US

(21) Appl. No.: 10/936,229

(22) Filed: Sep. 8, 2004

(51) Int. Cl. G02B 7/182

(52) U.S. Cl. 359/849

(57) ABSTRACT

An adaptive mirror system includes an array of phase mirror segments for correcting for errors in a wavefront incident on the mirror system; each phase mirror segment includes an integrated wavefront correction module, having an optical surface; a high spatial and temporal frequency correction system for deforming the optical surface to correct for high spatial and temporal frequency phase errors in the incident local wavefront on the optical surface; and a tip-tilt correction system for adjusting the optical surface to compensate for tip-tilt errors in the incident local wavefront.

### FIELD OF THE INVENTION

This invention relates to an adaptive mirror system, and more particularly to such a system having a plurality of phased segments implemented with integrated wavefront correction modules.

### BACKGROUND OF THE INVENTION

Present adaptive mirror systems use individual beam steering devices and deformable mirrors to correct tip-tilt errors and high spatial and temporal frequency errors in incident wavefronts, respectively. The use of discrete components requires added relay optics and the actuators are generally limited to 7 mm spacing. This all goes to making the adaptive mirror system large, complex, cumbersome, heavy and require substantial power which is acceptable for telescope systems but is not acceptable for industrial, medical and ophthalmologic applications. The large size and spacing of these systems also limits spatial frequency correction and spatial resolution. And the construction of these systems does not admit of easy economical scaling up.

### BRIEF SUMMARY OF THE INVENTION

It is therefore an object of this invention to provide an improved adaptive mirror system.

It is a further object of this invention to provide such an improved adaptive mirror system which is smaller, more light weight, less complex and requires less power.

It is a further object of this invention to provide such an improved adaptive mirror system which has better spatial and temporal frequency correction and better resolution.

It is a further object of this invention to provide such an improved adaptive mirror system which is less costly by a factor of five or more.

It is a further object of this invention to provide such an improved adaptive mirror system which is extremely accurate.

It is a further object of this invention to provide such an improved adaptive mirror system which is accurate to nano-meter levels.

It is a further object of this invention to provide such an improved adaptive mirror system which is dimensionally stable to sub-nanometer, Angstrom, or atomic levels.

It is a further object of this invention to provide such an improved adaptive mirror system which is easily economically scalable.

It is a further object of this invention to provide such an improved adaptive mirror system which has high bandwidth.

It is a further object of this invention to provide such an improved adaptive mirror system which uses a small, efficient, highly integrated wavefront correction module to implement the phase segments of the mirror.

It is a further object of this invention to provide such an improved adaptive mirror system with a compact smaller physical envelope.

It is a further object of this invention to provide such an improved adaptive mirror system scalable to many thousands of control channels.

The invention results from the realization that a smaller, lighter, simpler, less expensive, scalable, low power adaptive mirror system which has improved accuracy and dimensional stability with better spatial frequency correction and resolution is achieved by implementing the mirror phase segments using an integrated wavefront correction module having an optical surface together with both a high spatial and temporal frequency correction system for deforming the optical surface to correct spatial and temporal frequency errors and a tip-tilt system for adjusting the optical surface to compensate for tip-tilt errors in the incident local wavefronts.

This invention features an adaptive mirror system including an array of phased mirror segments for correcting for errors in a wavefront incident on the mirror system. Each including an integrated wavefront correction module. Each such module includes an optical surface and a high spatial and temporal frequency correction system for deforming the optical surface to correct for high spatial and temporal frequency phase errors in an incident local wavefront on the optical surface. A tip-tilt correction system adjusts the optical surface as well to compensate for tip-tilt errors in the instant local wavefront.

In a preferred embodiment, the high spatial and temporal frequency correction system is in series with the tip-tilt correction system and adjusts both the optical surface and the high spatial and temporal frequency correction system. The tip-tilt correction system and high spatial and temporal frequency correction system may be each connected to the optical surface. The tip-tilt correction system may include a plurality of actuators having a their force train application points clustered together proximate the center of the optical surface. The tip-tilt actuators may include tip-tilt multipliers to amplify the tilt motion. A tip-tilt multiplier may include an arm extending from a tip-tilt actuator toward the center axis of the optical surface. The optical surface may include a continuous face sheet. The high spatial and temporal frequency correction system may include a transverse electrodisplacive actuator array including a support structure and a plurality of ferroic electrodisplacive actuator elements extending from proximate end at the support structure to a distal end. Each actuator element may include at least one addressable electrode and one common electrode spaced from the addressable electrode and extending along the direction of the proximate and distal ends along the transverse d₃₁ train axis. There may be a plurality of addressable contacts, at least one common contact for applying voltage to the addressable and common electrodes to induce a transverse strain in addressed actuator elements to effect an optical phase change in the optical surface at the addressed actuator elements. The support structure and the actuator elements may be integral. The tip-tilt correction system may include a multi-axis transducer including a stack of ferroelectric layers and a plurality of common electrodes and addressing electrodes alternately disposed between the ferroelectric layers. Each of the addressing electrodes may include a number of sections electrically isolated from each other and forming a set with corresponding section in the other addressing electrodes. A common conductor electrically connects to the common electrodes. There are a number of addressing conductors. Each one is electrically connected to a different set of the sections of the addressing electrodes. The high spatial and temporal frequency correction system may include a plurality of mirror actuators. It may include at least three mirror actuators. The tip-tilt correction system may include a plurality of tip-tilt actuators, it may include at least three tip-tilt actuators.

### BRIEF DESCRIPTION OF THE DRAWINGS

Other objects, features and advantages will occur to those skilled in the art from the following description of a preferred embodiment and the accompanying drawings, in which:

FIG. 1 is a three dimensional view of an adaptive telescope system using one or more adaptive mirror systems according to this invention;

FIG. 2 is a three dimensional enlarged, detailed view of a portion of the primary, secondary or tertiary mirror systems according to this invention of FIG. 1 comprised of a plurality of integrated wavefront correction modules;

FIG. 3 is a three dimensional enlarged view of one of the integrated wavefront correction modules of FIG. 2, with a portion of the tip-tilt correction system broken away;

FIG. 4 is a three dimensional view of another embodiment of the integrated wavefront correction module similar to that of FIG. 3;

FIG. 5 is a simplified schematic view of a transverse electrodisplacive actuator employed in the integrated wavefront correction module;

FIG. 6 is a simplified schematic view of a transverse electrodisplacive actuator array using the transverse electrodisplacive actuator of FIG. 5;

FIG. 7 is a simplified schematic view of a transverse electrodisplacive actuator similar to FIG. 6 but with the common electrodes brought out through the support structure;

FIGS. 8 and 9 are three-dimensional views of a transverse electrodisplacive actuator array with increased numbers of actuator elements;

FIG. 10 is an exploded three dimensional view of the transverse electrodisplacive actuator array of FIG. 9 and its electrical interconnection;

FIG. 11 is a three dimensional view of the arrays of FIG. 9 in a modular arrangement with a driver circuit;

FIGS. 12 A-D illustrate the localized deformation of the mirror surface by the transverse electrodisplacive actuator array;

FIG. 13 is diagrammatic three-dimensional view of a multi-axis transducer employed in the integrated wavefront correction module;

FIG. 14 is a diagrammatic, side, elevational, sectional view along line 14-14 of FIG. 13;

FIG. 15 is an enlarged, exploded diagrammatic view of a portion of the transducer of FIG. 13 including several layers;

FIG. 16 is an enlarged schematic view of a layer similar to that of FIG. 15 with a pattern of common electrodes disposed therein;

FIG. 17 is an enlarged schematic view of a layer similar to that of FIG. 15 with a pattern of addressing electrodes disposed thereon;

FIG. 18 is a schematic side view of a transducer similar to that of FIG. 13 implementing a co-located sensor-actuator with the sensor and actuator portions configured longitudinally along the stack;

FIG. 19 is a schematic top view of a transducer similar to that of FIG. 13 implementing a co-located sensor-actuator with the sensor and actuator portions configured circumferentially, alternately around the stack;

FIG. 20 is a schematic diagram of a transducer similar to that of FIG. 13 illustrating the d₃₃ axis conformation;

FIG. 21 is a schematic diagram of a transducer similar to that of FIG. 13 illustrating the d₃₁ axis conformation;

FIG. 22 is a side elevational schematic view of a integrated wavefront correction module as in FIGS. 3 or 4 showing the electrical interconnection;

FIG. 23 is a side elevational schematic view similar to FIG. 22 showing an alternative technique for electrical interconnection;

FIG. 24 is a three dimensional elevational view showing one embodiment of the integrated wavefront correction module tip-tilt actuator with tip-tilt multipliers with their force train application points clustered together proximate the center of the optical surface; and

FIG. 25 is a side elevational schematic view of an integrated wavefront correction module in which the tip-tilt correction system and high spatial and temporal frequency correction system drive the optical surface independently.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

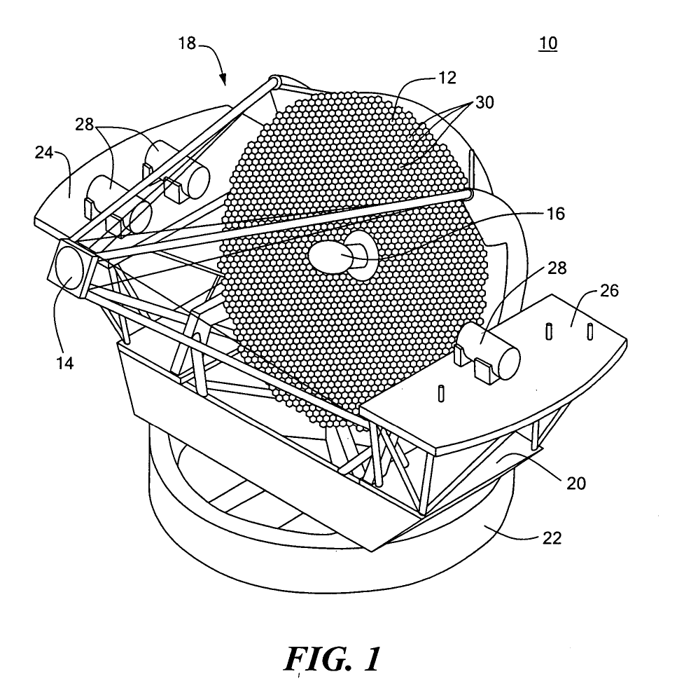

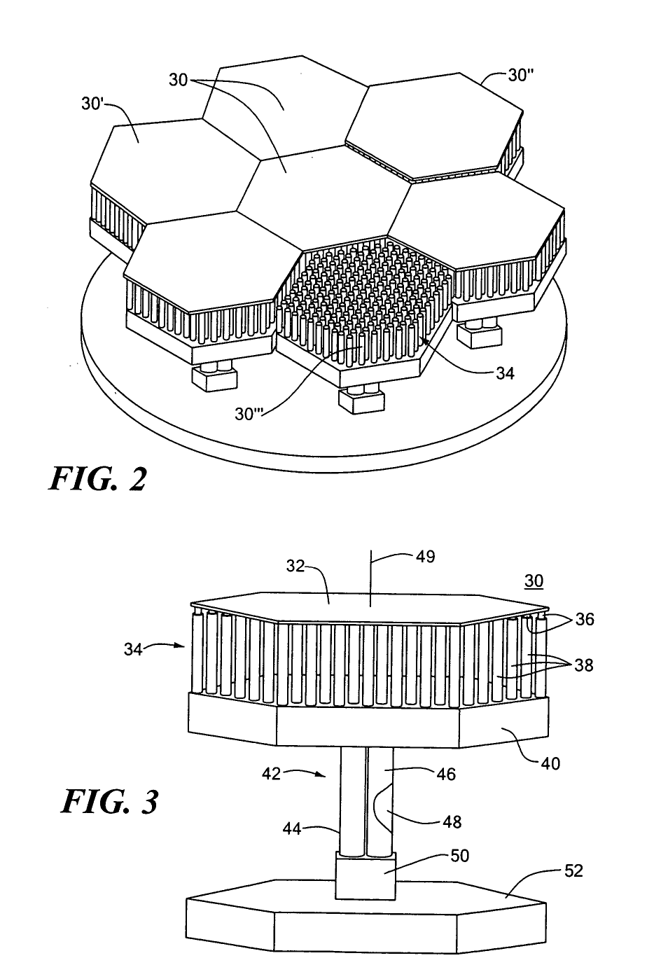

There is shown in FIG. 1 an adaptive telescope system 10 having one or more adaptive mirror systems according to this invention, such as, primary segmented mirror 12, secondary segmented mirror 14, and tertiary segmented mirror 16 all of which are mounted by means of the superstructure 18 on yolk 20 carried by pier 22. Instrument platforms 24, 26 carry instrumentation, controls and sensing equipment and circuits. Each of the mirrors, primary 12, secondary 14, and tertiary 16 are made up of phased segments implemented by integrated wavefront correction modules 30, a number of which are shown in FIG. 2 as having a hexagonal shape so that they can be easily nested. Module 30′ is shown in an activated position slightly below the surface of the other modules while 30″ is shown actuated to a slightly elevated level. Each module 30 includes a face sheet which has been removed in the case of module 30′″ so that the high spatial and temporal frequency correction system 34 can be more easily seen.

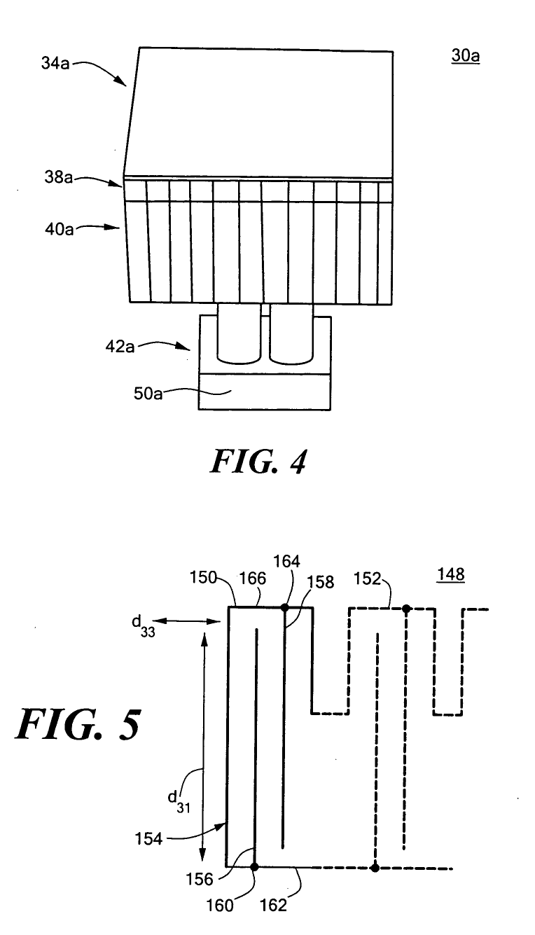

Module 30 is shown in greater detail in FIG. 3 where it can be seen that the face sheet 32 rests on flexures 36 carried by mirror actuator 38 mounted on base or reaction mass 40; face plate 32 may be continuous but need not be. High spatial and temporal frequency correction system 34 is in turn mounted on tip-tilt correction system 42 which includes three closely clustered tip-tilt actuators 44, 46 with portions broken away through which can be seen third actuator 48, this too may be mounted on a base 50, all of which may be carried on a larger base 52. Although thus far the integrated wavefront correction module 30 has been shown as hexagonal in shape, this is not a necessary limitation: it may be square as shown in FIG. 4 or it could be octagonal, rectangular or any other regular or irregular shape desired to form the proper overall mirror surface. Mirror actuators 38 may be XIRE4016's and tip-tilt actuators 44, 46, and 48 may be XIRE0750's both obtainable from Xinetics, Inc. of Devens, Massachusetts. These tip-tilt actuators would typically have a stroke of 10 to 40 microns while the mirror actuators would have a stroke of three to six microns. Tip-tilt correction system 42 may function as a beam steerer with large tip-tilt motion, smaller resolution and low frequency of operation or a fast steering mirror with small tip-tilt motion, higher resolution and broader bandwidth. The number of mirror actuators 38 may be more or fewer depending upon the spatial resolution desired. The tip-tilt correction system 42 alternatively may be any suitable drive system including electromagnetic actuators, such as voice coils, and stepper motors, piezoelectric actuators and the like.

Also, in one preferred embodiment, the high spatial and temporal frequency correction system may include a transverse electrodisplacive actuator array disclosed in U.S. patent application Ser. No. 10/730,514, entitled Transverse Electrodisplacive Actuator Array, by Mark A. Ealey, owned by the same assignee and herein incorporated in its entirety by this reference and such devices Photonex #49S3, 144S3, 1024S1 are obtainable from Xinetics, Inc, Devens, Mass.

In a preferred embodiment the tip-tilt correction system may include a multi-axis transducer as disclosed in U.S. patent application Ser. No. 10/914,450, filed Aug. 9, 2004, entitled Improved Multi-Axis Transducer, by Mark A. Ealey (XIN-103J) owned by the same assignee and herein incorporated in its entirety by this reference. Such devices X13DOF0510, X13DOF01020 are obtainable from Xinetics, Inc. Devens, Mass. Each will be explained in turn hereafter.

A transverse electrodisplacive actuator array 148 which may implement the high spatial and temporal frequency correction system 34 of the integrated wavefront correction module 30 includes a plurality of actuators, 150, 152, FIG. 5, mounted on support structure 154, which utilizes the strain along the transverse axis d₃₁, rather than along the longitudinal axis d₃₃ to expand and contract actuator 150. In this case, each actuator includes at least two electrodes, an addressable electrode, 156 and a common electrode 158. Addressable electrode 156 connects to contact 160 on the surface 162 of support structure 154, while common electrode 158 connects to contact 164, on surface 166. In the construction, according to this invention, the electrodes are generally parallel to the direction of expansion and contraction as opposed to transverse to it. One advantage is that the interfacial stress is no longer a factor, as any separation or crack that occurs is not in series with the force or displacement, but rather transverse to it, so that it will not effect the operation of the device. In addition, the stroke obtained is no longer dependent on the number of electrodes and ceramic layers in the laminate stack, but rather is dependent on the length of actuator 150, FIG. 5.

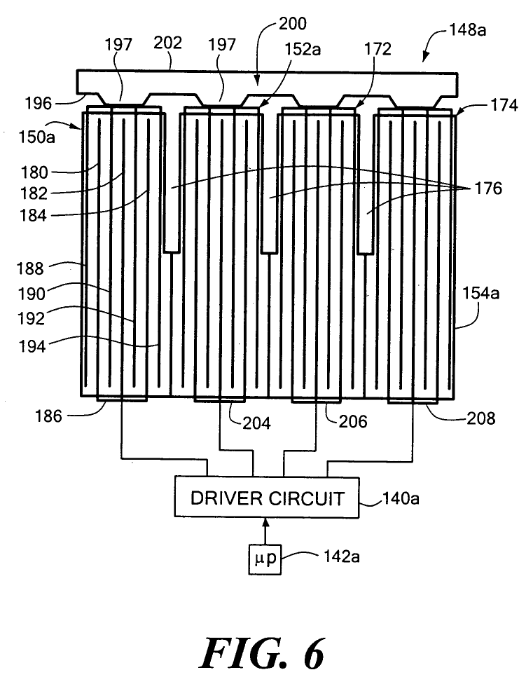

Actuator 150, 152, FIG. 5, may be a part of a larger array 148a, FIG. 6, which includes a number of actuators, 150a, 152a, 172, and 174. Actuators 150a, 152a, 172 and 174 are mounted on support structure 154a, which may be integral with them. Their separation may be effected by kerfs or saw cuts, 176, which separate them in two dimensions from each other, so they can act as independent elements. Also, as shown, each element may have more than just one addressable electrode and one common electrode. For example, as shown in FIG. 6 with respect to actuator 150a, there are three addressable electrodes, 180, 182, and 184, which are connected as a unit to addressable contact 186. And there may be more than one common electrode. For example, there may be four common electrodes 188, 190, 192, and 194 connected as a unit to common contact 196, which is plated on the mounting surface 198 of reflective member 200. Reflective member 200 contains on its other side the reflective surface 202, which is typically a continuous surface. Thus by selectively addressing addressable contact 186 one can cause actuator 150a to expand or contract and cause a bulge or depression in surface 202 in the locality of actuator 150a. Similarly when addressable contacts 204, 206, and 208 are selected surface 202 will be driven in the area local to the associated actuators 152a, 172, 174 respectively, to form a bulge or a depression depending upon the voltage applied to shape the optical wave front being reflected from surface 202. Typically the voltage applied may have a quiescent level at 70 volts, so that an increase of 30 volts will drive the actuator in one direction to expand or contract and a decease in voltage of 30 volts would drive it in the other. Detents 297 of mounting surface 298 are connected to actuators 152a, 154a, 172 and 174 by any suitable adhesive or bonding technique. The actuator elements have their proximate ends supported by the support structure. Their distal ends support the reflective member. The addressable and common electrodes are spaced apart and generally parallel to each other. The electrodes extend along in the direction of the proximate and distal ends of the actuator elements along the transverse d₃₁ strain axis.

The transverse electrodisplacive actuator array utilizes the transverse strain of a ferroic e.g. ferroelectric or ferromagnetic material such as an electrostrictive ceramic, lead magnesium niobate (PMN), to produce a scalable, large stroke microactuator which operates at low voltage and works well in the area of 293° K. (room temperature). Using other materials such as tungsten based or strontium based materials allows for operation in the area of 125K-200K and 30K65K, respectively. By utilizing the transverse strain component, the ceramic/electrode interfacial stress is reduced and the electrical interconnection of a densely packed structure is simplified. The electrode interface structure is less sensitive to machining tolerances, is more modular in terms of performance and reproducibility, and is more cost effective. Fewer laminates are required to form the actuator and the length is scaled to meet stroke requirements. Electrical interconnection is accomplished by incorporating printed circuit board technology in a common back plane. The transverse electrodisplacive actuator arrangement provides a scalable configuration compatible with up to 10⁷ channels of operation. The problems associated with the longitudinal multilayer actuator (electrical interconnects, interfacial stress, and precision machining during manufacture) are resolved by incorporating the transverse mode of operation. Array 148 may be made of a co-fired interleaved ceramic and electrode layers or may be made of a single crystal material such as but not limited to lead magnesium nitrate, lead zirconate nitrate.

The transverse electrodisplacive actuator array utilizes the transverse electrostrictive strain of PMN or other ferroic, ferroelectric or ferromagnetic material to produce a large stroke, low voltage displacement microactuator without requiring a stress sensitive multilayer construction process. Due to the transverse orientation, the structural load path is entirely through the ceramic, not through the electrode/ceramic interface. Furthermore, the interface stress is greatly decreased since the dimensional change in the longitudinal direction is small and inactive material mechanical clamping or pinning is eliminated. Stroke is attained by adjusting the length, not by adding additional layers.

Delineating a monolithic block of ceramic into discrete actuators is accomplished by standard microsawing techniques. The transverse configuration is a fault tolerant design which does not require precision tolerances to prevent damaging or shorting out electrodes during manufacture. Electrical interconnection of electrodes is greatly simplified. Electrical addressing of individual actuators is accomplished through the monolithic block which is polished and contains exposed electrodes. Printed circuit technology is used to provide the electrical interconnection between the discrete addressing actuator channels and the electronic driver. The result is a microactuator technology capable of providing sufficient stroke even at very small interactuator spacing without the need for multilayer construction or microscopic electrical interconnections. The design is easily fabricated without precision machining and is extremely stress tolerant during electrical activation. Furthermore, the design is inherently low voltage which is compatible with hybrid microelectronic driver technology. Electrical addressing and interconnection is done at a common back plane which lends itself to transverse scaling. The concept provides a high performance, scalable microactuator technology using conventional electroceramic fabrication and processing technology.

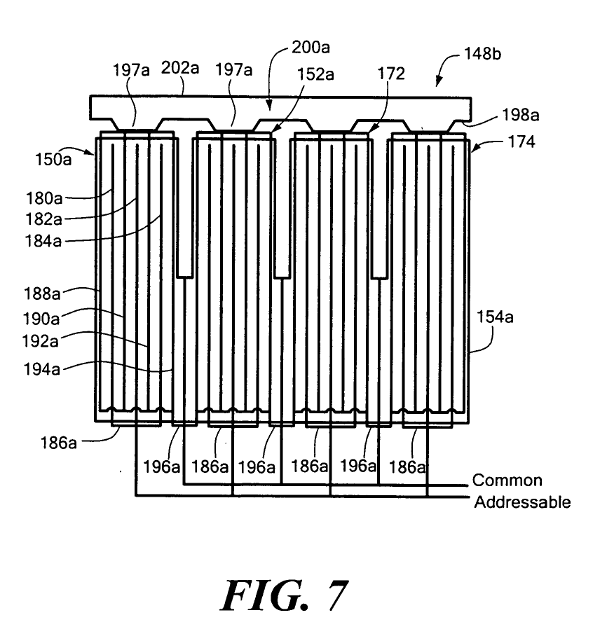

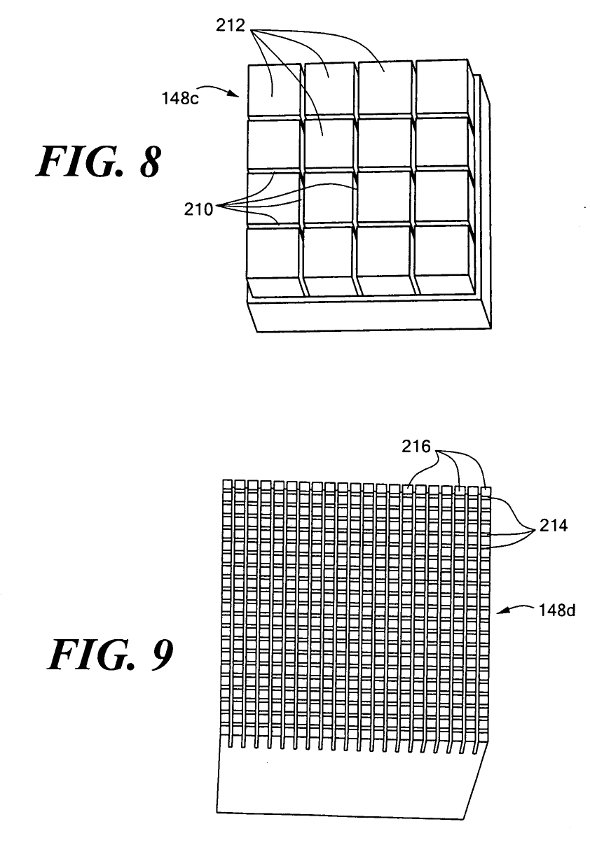

Although in FIG. 6 the transverse electrodisplacive actuator array was shown having its common electrode 196 carried by the mounting surface 198 of reflective member 200 this is not a necessary limitation. As shown in FIG. 7, in array 148b, reflective member 200a may be constructed without a contact on its mounting surface 198a and instead the common contacts 196a for the common electrodes may be established at surface 199. In that way the array including actuators 150a, 152a, 172 and 174 may be fully powered and tested before the reflective member, 200a is attached by bonding or adhesive.

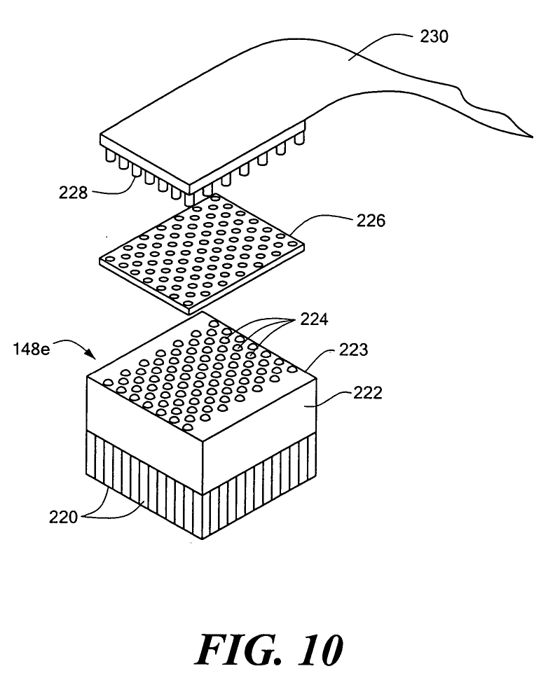

The entire array, both the support structure 154a, and the actuators 150a, 152a, 172 and 174 may be made by effecting cuts in two mutually perpendicular directions down into a block of suitable material ferric ceramic with the cuts or kerfs effecting the separation of the actuators into the individual elements. There may just a few cuts, 210, and resulting actuators, 212, as shown with respect to array 148c, FIG. 8 or there may be many cuts, 214, resulting in many actuators, 216, as shown with respect to array 148d, FIG. 9. The interconnection of transverse electrodisplacive actuator array 148e, FIG. 10 having a multiplicity of actuators 220, carried by support structure 222, may be made by forming the contacts 186a and 196a, FIG. 7, on the lower surface 223, FIG. 10, using solder pads, 224, on top of which is fastened a socket grid array, 226, to receive the pin grid array, 228 carried by flex cable 230.

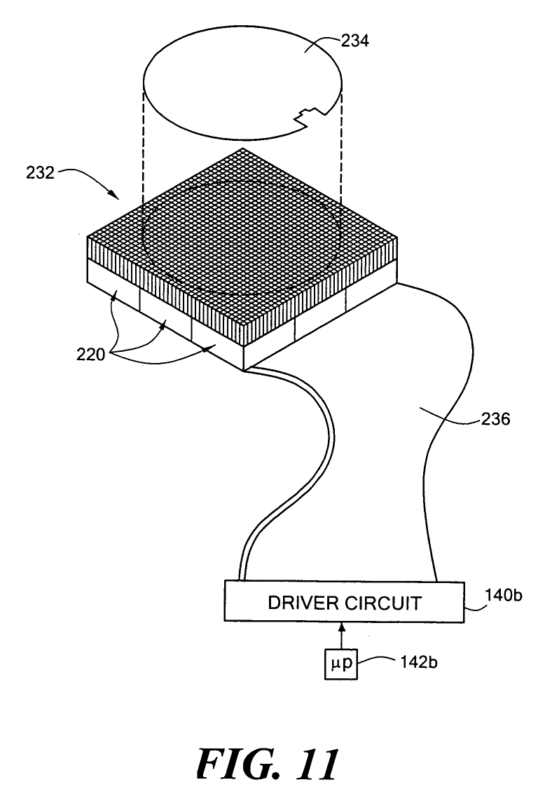

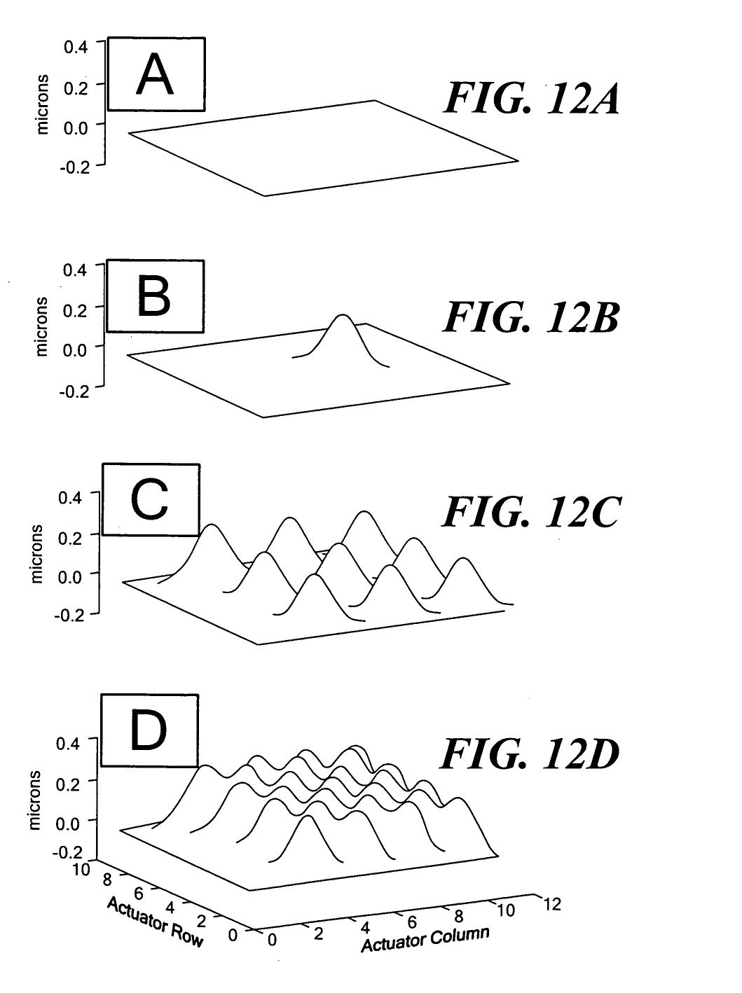

The advantageous modularity of the transverse electrodisplacive actuator array according to this invention is displayed in FIG. 11, where it can be seen that a number of smaller transverse electrodisplacive actuator arrays 220, FIG. 10 are combined in FIG. 11, to form a larger assembly, 232, to accommodate a much larger reflective member, 234 which also may be a continuous surface. Now all of the flex cables represented by a single cable, 236, are connected to driver circuit, 140b, which is driven by microprocessor 142b. With selected programming of driver circuit 140b by microprocessor 142b, it is possible to have an unenergized active aperture as shown in FIG. 12A; a single actuator energized to about 250 nm as shown in FIG. 12B, every third actuator energized as shown in FIG. 12C or every other actuator energized as shown in FIG. 12D. Multiple modules comprising 441 actuators or more having one-millimeter spacing arranged in 21 by 21 arrays have been demonstrated. Mirror deformations have been obtained, which are 0.25 micrometers at 100 volts and are repeatable to λ/1000 rms. The average capacitance for each actuator may be 30 nf while the average stroke may be 250 nm.

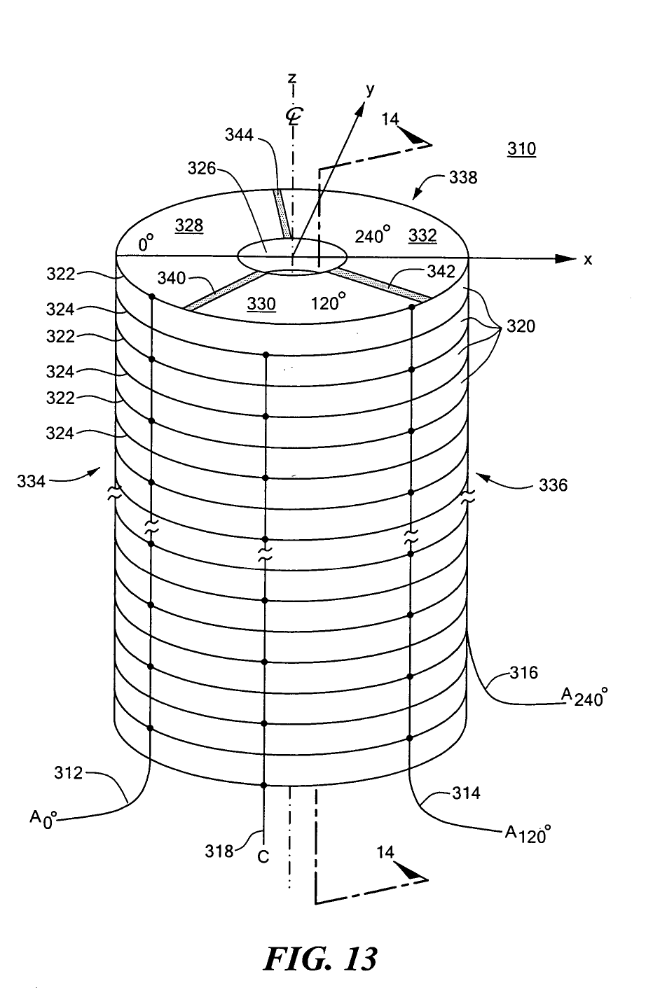

A multi-axis transducer 310, FIG. 13, which may implement the tip-tilt correction system 42 of the integrated wavefront correction module 30 includes addressing conductors 312, 314 and 316 and common conductor 318. Transducer 310 is formed of a plurality of layers typically numbering in the tens or hundreds. The layers are separated by electrodes, alternately common electrodes and addressing electrodes. Layers 320 are made of a ferroelectric electrodisplacive material, such as electrostrictive, piezoresistive, piezoelectric, or pryoresistive materials e.g. lead magnesium nitrate, lead zirconate titanate. Disposed between alternate layers are addressing electrodes 322 with the common electrodes 324 being interstitially alternately disposed These combinations of layers and electrodes form capacitors which may be viewed as mechanically in series and electrically in parallel. The layers 320 may be very thin, for example, 4 mils as compared to the prior art longitudinal walls which are 40 to 100 mils thick, those prior art devices required a 1000v to 2500v voltage supplies where as this structure using 4 mil layers would require only approximately 100 volts. Further when this transducer is operated as an actuator it will have greater displacement because it has a greater number of layers and displacement is a function of the number of layers squared times the electric field:
D≈N²×E (1)
where
E=V/t (2)
and where V is the voltage and t is the thickness.

When operated as a sensor transducer 310 performance is also improved because the co-firing which results in a monolithic integrated structure increases the stiffness of the device, and therefore gives it a greater sensitivity to any applied forces.
F≈^{ρY}/_{A} (3)
where ρ is density, A is area and Y is Young's Modulus. The higher the Young's Modulus the stiffer the device and therefore the greater will be the sensitivity of the device as a sensor and the greater will be the force developed by the device as an actuator. Co-firing also produces an integrated structure wherein the electrodes, layers and even the addressing and common conductors are an integral part of the package. The greater stiffness also increases the bandwidth of the transducer

$${f}_{r} = \frac{1}{2 π} \sqrt{\frac{k}{m}} \qquad ( 4 )$$

where k is stiffness, m is mass and fᵣ is the natural frequency and

$$k = \frac{Ya}{l} \qquad ( 5 )$$

where l is the length of the transducer. Co-firing is a well known fabrication process which involves removing carbon from the green body during binder burnout and densifying the ceramic during sintering with the result being a monolithic multilayer stack. For further information see Ceramic Processing and Sintering, M. N. Rahamen, Principles of Ceramic Processing, James S. Reed.

Each addressing electrode 322 includes two or more sections. In FIG. 13, the addressing electrodes 322 include three sections 328, 330 and 332 but fewer, two, or more 6, 10, 50, 100, 500 or any number may be used limited only by the manufacturing tolerances and the resolution desired. Transducer 310 is typically cylindrical in form and circularly symmetrical about centerline C/L and may have a central hole 326 to improve its performance. Each section 328, 330, 332 in each addressing electrode 322 forms a set with a corresponding sections in the other addressing electrodes. That is to say, all of the sections 328 in all of the addressing electrodes 322 which are connected by addressing conductor 312 form a set as do all the sections 330 interconnected by addressing conductor 318 and all of the sections 332 interconnected by addressing conductor 316. These sets are referred to as 334, 336, and 338, respectively.

When transducer 310 is operated as a actuator an electric field is created in layers 320 by applying a voltage across the pairs of addressing and common electrodes through addressing conductors 312, 314 and 316 and common conductor 318. If all of the applied voltages are equal, a displacement is generated in the Z axis longitudinally, if unequal voltages are applied then the sets 334, 336, 338 of sections 328, 330, and 332 will undergo different displacements and there will be a tilting, imposing a motion in the X and Y axes as well. Each of sections 328, 330 and 332 on each of addressing electrodes 322 are electrically isolated from each other, such as by insulating portions 340, 342 and 344.

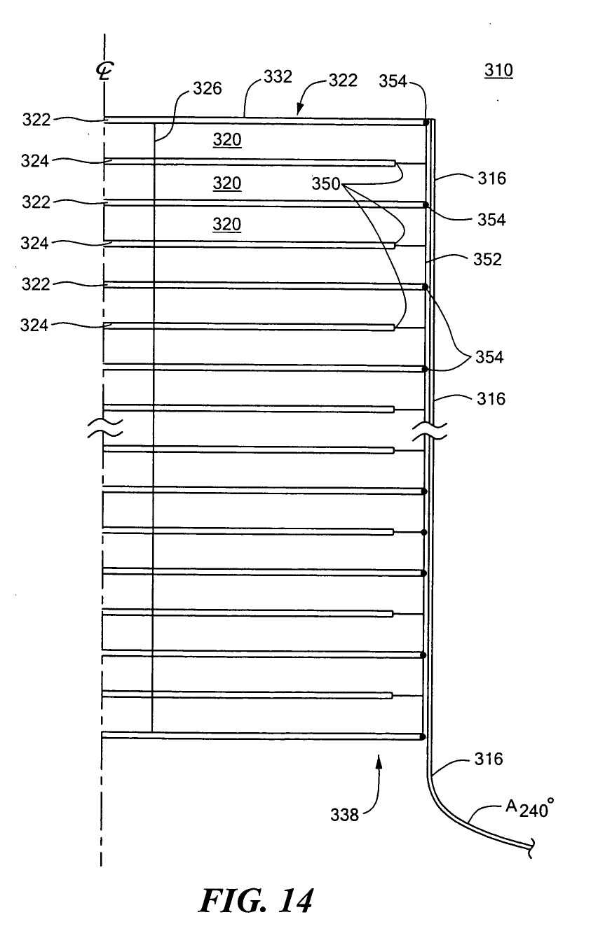

In order to ensure that the addressing conductors 312, 314 and 316 touch only addressing electrodes, not common electrodes, and that common conductor 318 touches only common electrodes, not addressing electrodes, the addressing and common electrodes are suitably configured with recesses. For example, each of common electrodes 324, FIG. 14, is recessed from the edge 352 of the stack of layers 320 so that it cannot electrically connect to addressing conductor 316 which is electrically interconnected to each of the addressing electrodes 322, such as at terminals 354. Similar recessing is done of the addressing electrodes to avoid contact with all but the common conductor.

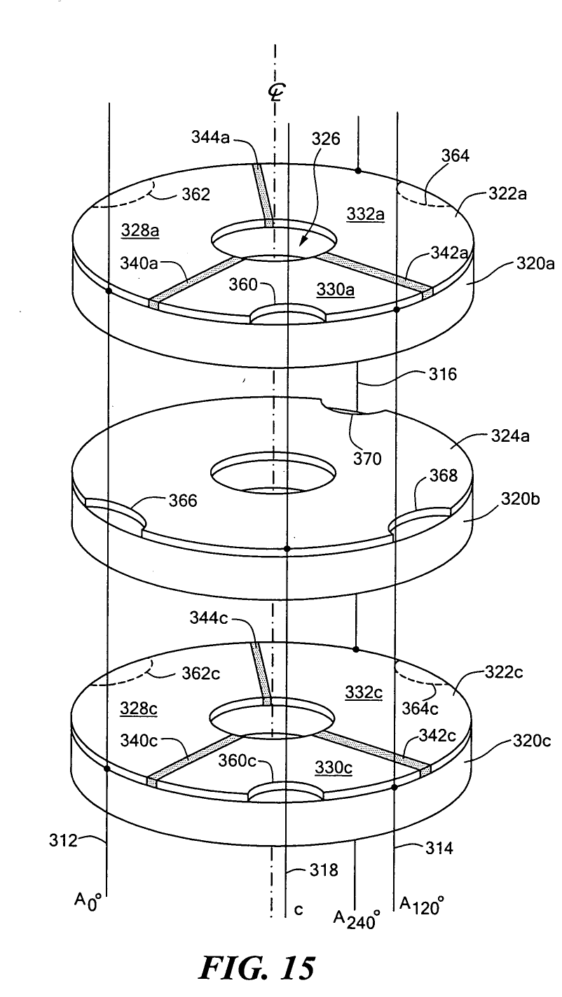

This construction can be seen in more detail in FIG. 15, where three layers 320a, 320b and 320c are shown in exploded isometric view. Addressing electrode 322a includes three sections 328a, 330a and 332a electrically separated by insulators 340a, 342a, and 344a. A portion of section of 330a is recessed as at 360, in fact only one recess is needed where there is typically only one common conductor, but for ease of manufacturing and assembly recesses are often provided in each of the sections as shown in phantom at 362 and 364. Common electrode 324a includes three recesses 366, 368, and 370 to be sure that there is no contact with addressing conductors 312, 314, and 316, respectively. The next layer 320c includes an addressing electrode 322c having three sections, 328c, 330c, and 332c with insulators 340c, 342c, and 344c and recesses 360c, 362c, and 364c.

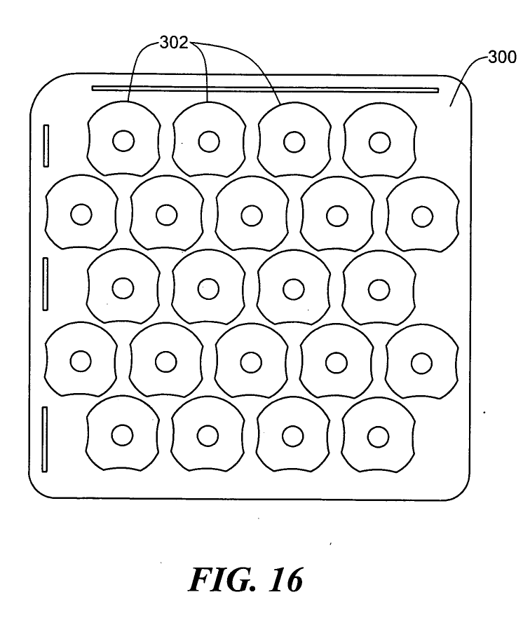

The transducer of this invention may be easily fabricated by fabricating a number of ferroelectric layers 400, FIG. 16, on which have been developed common electrodes 402 and fabricating a number of ferroelectric layers 404 on which have been developed a number of addressing electrodes 406, FIG. 17. Hundreds of these layers 400 and 404 are then stacked alternately and in registration following which the individual stacks of addressing and common electrodes are cut from the substrate and co-fired to form a number of transducers according to this invention.

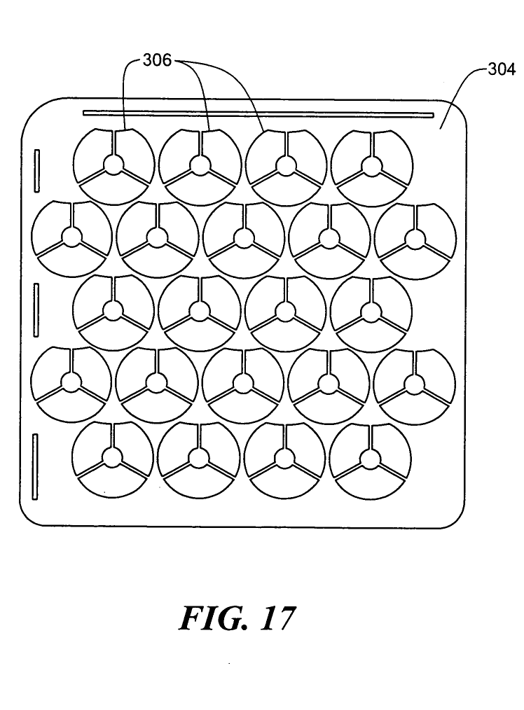

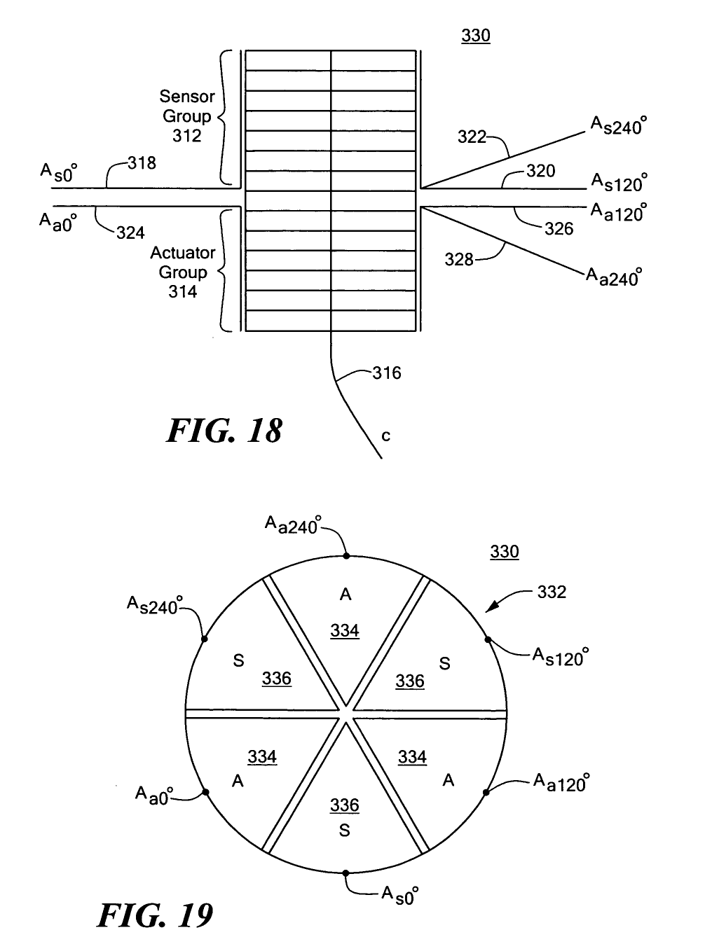

Although thus far the transducer has been referred to as operating as either a sensor or actuator it may function as a co-located combination sensor and actuator. Such a co-located sensor actuator 410, FIG. 18, is constructed in the same way as the transducer shown in FIGS. 13, 14 and 15, except that one group of addressing electrodes is designated the sensor group 412, and the other group of addressing electrodes is designated as the actuator group 414. There may still be one common conductor 416 but now there are addressing conductors 418, 420 and 422, one for each of the addressing electrodes in sensor group 412 and separate addressing conductors 424, 426, 428 for the addressing electrodes in the actuator group 414.

The same co-location sensor-actuator function can be obtained using a different confirmation as shown in FIG. 19, where transducer 430 is shown having each of its addressing electrodes 432 separated into a number of sections which are alternately actuator sections 434 and sensor sections 436 disposed on the same layer. Thus each of the addressing electrodes has an alternating pattern of actuator and sensing sections which form three sets of sensing sections interstitially disposed with respect to three sets of actuator sections. In both transducers 410 and 430 in FIGS. 18 and 19, the result is a co-located integrated and monolithic, co-fired, transducer which can operate both as a sensor and as an actuator to provide both displacement and force sensing. Alternatively, the device in FIG. 18 could have every other capacitor plate act as an actuator and the interstitial ones act as a sensor, instead of having two distinct groups as shown.

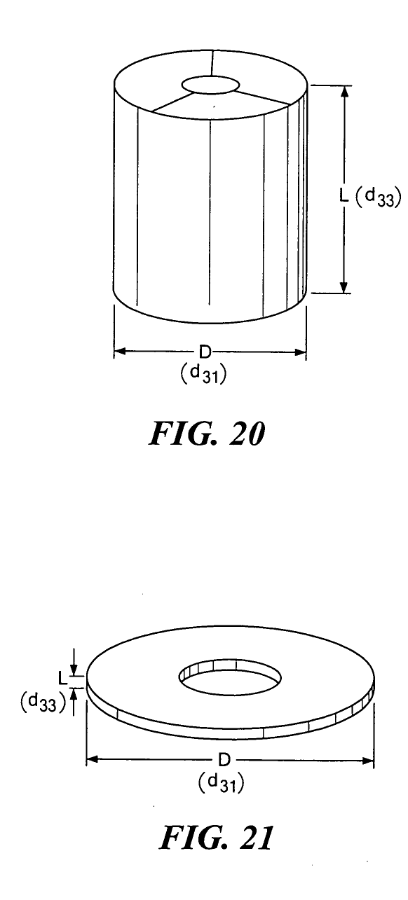

With the configuration shown thus far, where the transducer is shaped as an elongated cylinder, as shown in FIG. 20, where the length L is much greater than the diameter D, the better performance is along the longitudinal access or the d₃₃ axis. However, the transducer of this invention works just as well when d₃₁ is the preferred axis, if the aspect ratio is reversed so that the diameter D, FIG. 21, is much greater than the length L.

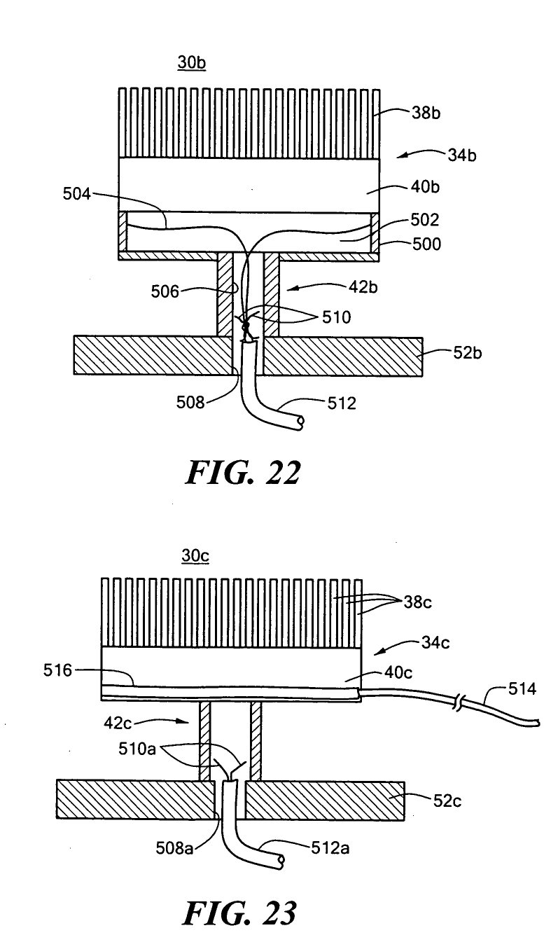

As is well know in the art, sensing and control circuits, such as disposed in the instrument and control packages 28, FIG. 1, include sensors and circuits for sensing high spatial and temporal frequency errors and tip-tilt errors in the incident wavefronts on the telescope system, for example e.g. on face plates 32. These circuits, which form no part of this invention, develop compensation signals which are then applied to the tip-tilt correction system in high spatial and temporal frequency correction system to correct for those errors. The interconnection of those circuits can be done in a number of ways. Base or reaction mass 40b, FIG. 22, can include a framework 500 having a space 502 for accommodating the wire interconnects 504 from high spatial and temporal frequency correction system 34b which then passes through a central hole 506 in tip-tilt correction system 42b whether it be a plurality of discrete actuators or a multi-axis transducer and then through a similar hole 508 in base 52b. Interconnect wires 510 join them in cable 512 passing through hole 508. Alternatively, integrated wavefront correction module 30c, FIG. 23, may include a flat cable 514 which interconnects through the contacts on base 40c for each of the actuators 38, and then is covered by a protective insulating layer 516 to which may be mounted the tip-tilt correction system 42c. Once again it can be driven by wire connections 510a, which are lead through hole 508a to cable 512a.

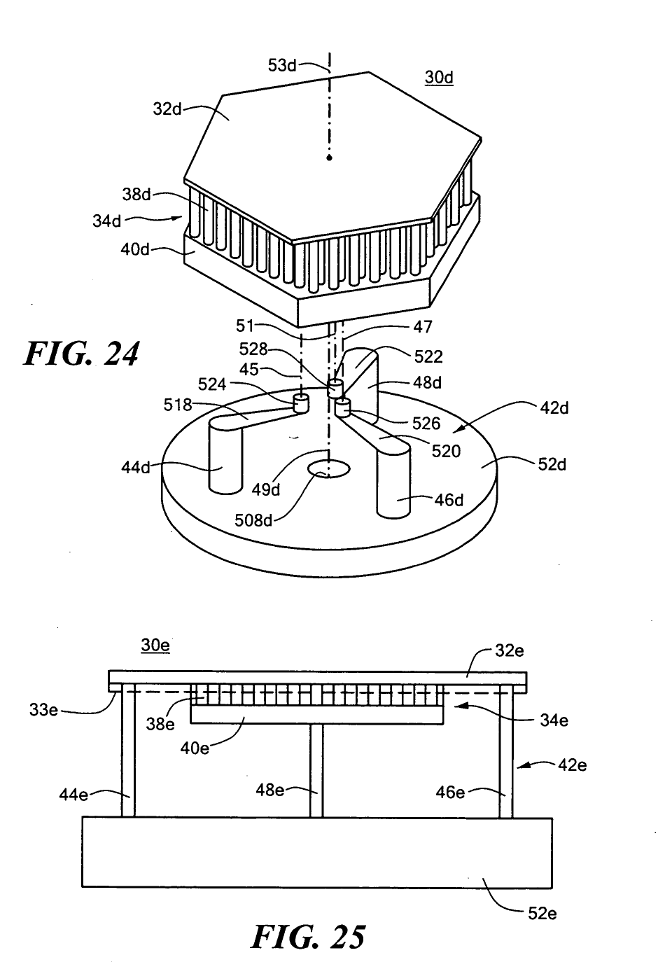

Whether the tip-tilt correction system 42d, FIG. 24, is a plurality of discrete tip-tilt actuators, such as 44, 46, and 48 shown in FIG. 3, or a single multi-access actuator as shown in FIG. 13, it is advantageous to have the force train application points clustered together proximate the center of the optical surface, which is the fulcrum for the tip-tilt motion, in order to gain the most motion amplification for the tip-tilt motion of the mirror. In FIG. 3 the force train application point axes 45 and 47 of actuator 44, and 46 and the axis of actuator 48, not shown, are close to the center of rotation axis 49 of mirror surface 32. Using the multi-axis transducer of FIG. 13, the force train application point axes are close together and proximate the center of the optical surface as well, but this is not a necessary limitation. For example, integrated wavefront correction module 30d, FIG. 24, includes three discrete tip-tilt actuators 44d, 46d, and 48d. Spaced well apart from the rotation center axis 49d which passes through the center of hole 508d on base 52d and through the center of rotation 53d of mirror surface 32d. But each of these tip-tilt actuators 44d, 46d and 48d includes an arm 518, 520 and 522 which extends from the top of its associated actuator towards the center line 49d. There the force train application points 524, 526 and 528 have their axes 45, 47 and 51 respectively, clustered together and close to the center axis 49d, thereby garnering the mechanical advantage of being close to the fulcrum point, center of rotation 53d, to provide motion amplification for the tip-tilt motion. This is but one example of many different mechanical advantage systems that could be used for this purpose.

Although thus far the integrated wavefront correction module has been shown with the high spatial and temporal frequency correction system being mounted on the tip-tilt correction system so that the tip-tilt correction system actually moves the entire high spatial and temporal frequency correction system in turn applying the tip-tilt correction to optical surface 32d, this is not a necessary limitation. The two correction systems could be applied in parallel as shown in FIG. 25 where integrated wavefront correction module 30e includes tip-tilt correction system 42e having three spaced apart tip-tilt actuators 44e, 46e and 48e which support optical surface or face plate 32e. Suspended from faceplate 32e is high spatial and temporal frequency correction system 34e so that while high spatial and temporal frequency correction system 34e is indeed still moved by tip-tilt correction system 42e it is not in series with it. For tip-tilt correction system 42e doesn't move faceplate 32e through high spatial and temporal frequency correction system 34e but independently and so does the high spatial and temporal frequency correction system 34e. This requires an extremely light weight high spatial and temporal frequency correction system 34e to be carried by face plate 32e or there could be a stiffening layer as shown in 33e, shown in phantom, to provide the necessary stiffness.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. An adaptive mirror system comprising:
an array of phased mirror segments for correcting for errors in a wavefront incident on said mirror segments, each including an integrated wavefront correction module including an optical surface;
a high spatial and temporal frequency correction system for deforming said optical surface to correct for high spatial and temporal frequency phase errors in an incident local wavefront on said optical surface; and
a tip-tilt correction system for adjusting said optical surface to compensate for tip-tilt errors in the incident local wavefront.

2. The adaptive mirror system of claim 1 in which said high spatial and temporal frequency correction system is in series with said tip-tilt correction system and adjusts both said optical surface and said high spatial and temporal frequency correction system.

3. The adaptive mirror system of claim 1 in which said high spatial and temporal frequency correction system and said tip-tilt correction system are each connected to said optical surface.

4. The adaptive mirror system of claim 1 in which said tip-tilt correction system includes a plurality of actuators having their force train application points clustered together proximate the center of said optical surface.

5. The adaptive mirror system of claim 1 in which said tip-tilt actuators include tip-tilt multipliers to amplify the tilt motion.

6. The adaptive mirror system of claim 5 in which a said tilt-tip multiplier includes an arm extending from a said tip-tilt actuator toward the center axis of said optical surface.

7. The adaptive mirror system of claim 1 in which said optical surface includes a continuous face sheet.

8. The adaptive mirror system of claim 1 in which said high spatial and temporal frequency correction system includes a transverse electrodisplacive actuator array including a support structure; a plurality of ferroic electrodisplacive actuator elements extending from a proximate end at said support structure to a distal end; each actuator element including at least one addressable electrode and one common electrode spaced from said addressable electrode and extending along the direction of said proximate and distal ends along the transverse d₃₁ strain axis; and a plurality of addressable contacts and at least one common contact for applying voltage to said addressable and common electrodes to induce a transverse strain in addressed actuator elements to effect an optical phase change in the optical surface at the addressed actuator elements.

9. The adaptive mirror system of claim 8 in which said support structure and said actuator elements are integral.

10. The adaptive mirror system of claim 1 in which said tip-tilt correction system includes a multi-axis transducer including a stack of ferroelectric layers; a plurality of common electrodes and addressing electrodes alternately disposed between the ferroelectric layers; each of said addressing electrodes including a number of sections electrically isolated from each other and forming a set with corresponding sections in the other addressing electrodes; a common conductor electrically connected to said common electrodes; and a number of addressing conductors, each one electrically connected to a different said set of said sections of said addressing electrodes.

11. The adaptive mirror system of claim 1 in which said high spatial and temporal frequency correction system includes a plurality of mirror actuators.

12. The adaptive mirror system of claim 11 in which said high spatial and temporal frequency correction system includes at least three mirror actuators.

13. The adaptive mirror system of claim 1 in which said tip-tilt correction system includes a plurality of tip-tilt actuators.

14. The adaptive mirror system of claim 13 in which said tip-tilt correction system includes at least three tip-tilt actuators.
